(19) United States
(12) Patent Application Publication
(10) Pub. No.: US 2025/0020971 A1
(43) Pub. Date: Jan. 16, 2025

(54) PHONON-MEDIATED UPCONVERSION METHODS

(71) Applicant: Cornell University, Ithaca, NY (US)

(72) Inventors: Jiaoyang Zheng, Ithaca, NY (US); Guru Bahadur Khalsa, Ihtaca, NY (US); Jeffrey Moses, Ithaca, NY (US)

(21) Appl. No.: 18/771,419

(22) Filed: Jul. 12, 2024

Related U.S. Application Data
(60) Provisional application No. 63/526,403, filed on Jul. 12, 2023.

(51) Int. Cl. G02F 1/35; H01S 3/00

(52) U.S. Cl. CPC G02F 1/354; G02F 1/3536; H01S 3/0092

(57) ABSTRACT

A phonon-mediated upconversion method includes exciting a Raman phonon in a crystal by illuminating the crystal with a number of pump beams each having a same pump frequency equal to one half of a phonon frequency of the Raman phonon. The method also includes generating an upconverted beam by illuminating the crystal with at least one of the number of pump beams while the Raman phonon is at least partially excited. The upconverted beam has an upconverted frequency that is three times the pump frequency.

### CROSS-REFERENCE TO RELATED APPLICATIONS

This application claims the benefit of U.S. Provisional Application No. 63/526,403, filed on 12 Jul. 2023, the disclosure of which is incorporated herein by reference in its entirety.

### STATEMENT REGARDING FEDERALLY SPONSORED RESEARCH OR DEVELOPMENT

This invention was made with government support under grant number DMR-1719875 awarded by the National Science Foundation. The government has certain rights in the invention.

### BACKGROUND

The close connection between structure, symmetry, and function is a principal driver of the search for new quantum materials. Leveraging this connection, prospects for ultrafast control of quantum materials have emerged employing the direct excitation of the crystalline lattice with light. Already, striking changes to functional properties such as superconductivity, magnetism and ferroelectricity have been achieved through the strong coupling between Raman-active phonons and infrared-active (IR-active) phonons driven by resonant THz laser pulses within the anharmonic regime. Alongside the manipulation of crystal structure, new research has focused on imparting giant changes to the optical properties of crystals through resonant IR-phonon excitation, mediated by the anharmonic lattice potential or nonlinear ionic displacement polarizability. The resulting strong optical nonlinearities may have considerable significance for photonics applications involving THz light.

### SUMMARY OF THE EMBODIMENTS

When IR-active phonons are absent or Raman-IR coupling is weak, alternative strategies for coherent structural and optical property control are imperative. A Raman-active phonon coherence may be driven by two light fields with either a sum-frequency or difference-frequency beat note resonant with the Raman frequency Ω_{R}. As standard laser frequencies are far higher than phonon frequencies (usually <50 THz), the difference-frequency pathway, driven by visible or near-IR light fields, is by far the most familiar case in Raman scattering processes. Nonetheless, as strong table-top THz light sources have advanced, a recent development in crystalline solids is to establish Raman coherence via a sum-frequency beat note of the applied THz fields E(ωᵢ)—a frequency range that avoids electronic heating—where 2ωᵢ=Ω_{R}, as FIG. 1(a) shows.

Two-photon absorption (TPA) of incident THz light (section (b) of FIG. 1) is an inelastic optical scattering effect accompanying SFE of Raman coherence. This stems from a third-order polarizability at the incident frequency, causing nonlinear absorption of THz pump at a rate proportional to its intensity (See equation A7). TPA in this context is analogous to stimulated Raman scattering (SRS), which is an inelastic optical scattering effect that accompanies a difference-frequency excitation of a Raman-active phonon. In the case of SRS, optical scattering is incompletely inelastic, with energy transferred from high frequency to low frequency photons. In the case of TPA, it is completely inelastic. In both cases, the absorbed optical energy promotes an increase in phonon excited-state population.

Section (a) of FIG. 1 shows a sum-frequency pathway for Raman coherence establishment. Section (b) of FIG. 1 shows its associated inelastic two-photon scattering process, TPA. Section (c) of FIG. 1 illustrates an embodiment of an elastic four-wave mixing process, phonon-mediated third-harmonic generation (PM-THG). In FIG. 1, |v₀ [symbol] , |v₁ [symbol] are ground and excited states of a Raman-active phonon. |e [symbol] is a virtual electronic state.

The present embodiments include devices and methods for performing frequency upconversion by using pump light to resonantly, or near resonantly, excite a Raman phonon in a crystal via a sum-frequency response. With the Raman phonon excited, pump light is upconverted by the frequency of the Raman phonon. This frequency upconversion process is elastic, meaning no light is absorbed during the process. The output of the crystal is upconverted light whose frequency is greater than that of the pump light.

In embodiments, this frequency upconversion manifests itself as third-harmonic generation. In the accompanying appendices, this process is referred to as “phonon-dressed third-harmonic generation.” However, third-harmonic generation is just one type of nonlinear optical process than may be performed with the present embodiments. Furthermore, while diamond was used as the crystal to demonstrate phonon-dressed third-harmonic generation in the accompanying appendices, the present embodiments may be used with other types of crystals and solid-state materials.

In some of the present embodiments, devices and methods perform a spectroscopic technique in which Raman phonons are detected by the generation of a coherent optical signal at three times the incident frequency or at the Raman phonon frequency plus the probe frequency.

Some of the present embodiments work in the infrared and THz frequency regions of the electromagnetic spectrum, which are appropriate for resonantly or near-resonantly exciting Raman phonons. The present embodiments use condensed matter phase materials and their heterostructures. The coupling to optical phonons produces an enhanced up-conversion to the frequency of input light. This allows for the efficient creation of photons/light with frequencies that may cover the telecommunications range. The present embodiments also have enhanced orientation-angle, polarization, and frequency sensitivity.

In embodiments, third-harmonic generation is performed via a sum-frequency resonance with a Raman phonon. While prior-art devices have done this in a gas phase (e.g., molecular systems), the present embodiments are implemented in solid-state materials (i.e., any system that supports one or more phonons). Molecular systems do not have polarization dependence and cannot be periodically modulated to achieve large coherent signal. In embodiments, the polarization of the input pump light is rotated, or the relative orientation of the crystal is altered, to sensitively measure and/or control the orientation.

In embodiments, the upconverted light is used for spectroscopy of the temporal evolution of underlying structural changes in the crystal, either inherent in the underlying process or seeded by another source.

The present embodiments include a solid-state device that may be used as an optical switch in which a first pump pulse having a first frequency that is less than that of the Raman phonon enables the upconversion of a second pump pulse having a second frequency that is also less than that of the Raman phonon.

The present embodiments may be used with any of several types of crystalline optical material, with a thickness chosen for phase-matching the desired frequency upconversion. The crystal may also be a layered structure that enhances the upconverted signal via frequency-tuned quasi-phase-matching. Such a layered structure may be made by epitaxial and optical material growth techniques known in the art, e.g., heterostructuring, isotope grading, etc. performed via chemical vapor deposition, molecular beam epitaxy, etc. The structure for quasi-phase-matching may also be produced through the known art of ferroelectric domain poling.

In a first aspect, a first phonon-mediated upconversion method is disclosed. The method includes exciting a Raman phonon in a crystal by illuminating the crystal with a number of pump beams each having a same pump frequency equal to one half of a phonon frequency of the Raman phonon. The method also includes generating an upconverted beam by illuminating the crystal with at least one of the number of pump beams while the Raman phonon is at least partially excited. The upconverted beam has an upconverted frequency that is three times the pump frequency.

In a second aspect, a second phonon-mediated upconversion method is disclosed. The method includes exciting a Raman phonon in a crystal by illuminating the crystal with a plurality of pump beams each having a respective one of a plurality of pump frequencies. A phonon frequency of the Raman phonon being equal to either (i) two times one of the plurality of pump frequencies or (ii) a sum of the plurality of pump frequencies. The method also includes generating an upconverted beam by illuminating the crystal with at least one of the plurality of pump beams while the Raman phonon is at least partially excited. The upconverted beam has an upconverted frequency equal to either (i) the phonon frequency plus one of the plurality of pump frequencies or (ii) the phonon frequency minus one of the plurality of pump frequencies.

In a third aspect, a third phonon-mediated upconversion method is disclosed. The method includes exciting a Raman phonon in a crystal by illuminating the crystal with three pump beams. Each of the three pump beams has a respective one of three distinct pump frequencies. A phonon frequency of the Raman phonon is equal to a sum of two of the three distinct pump frequencies. The method also includes generating an upconverted beam by illuminating the crystal with the three pump beams while the Raman phonon is at least partially excited. The upconverted beam has an upconverted frequency equal to either (i) a sum of the three distinct pump frequencies or (ii) the phonon frequency minus one of the three distinct pump frequencies.

### BRIEF DESCRIPTION OF THE FIGURES

FIG. 1. shows sum-frequency pathways for Raman coherence establishment.

FIG. 2 includes a schematic of third-harmonic generation (THG) according to embodiments herein, and incident pump and emitted third-harmonic spectra, obtained with the crystal plate oriented to increase or maximize the observed THG power.

FIG. 3 includes plots of THG power enhancement, signal spectral, and intensity, resulting from an embodiment THG method disclosed herein.

FIG. 4 includes plots of THG power enhancement factor as a function of pump central frequency and bandwidth resulting from an embodiment THG method disclosed herein.

FIG. 5 is a functional block diagram of a phonon-mediated sum-frequency generator, in embodiment.

FIGS. 6, 7, and 8 are flowcharts illustrating respective embodiments of phonon-mediated upconversion methods.

FIG. 9 compares Raman coherence establishment and associated optical effects via sum-frequency and difference-frequency pathways.

FIG. 10 shows the spectral intensity of the spontaneous Raman signal generated from a diamond sample according to an embodiment of methods disclosed herein.

FIG. 11 shows PM-THG and the non-resonant electronic-THG intensities generated according to an embodiment of a THG method disclosed herein.

FIG. 12 presents the pump spectra corresponding to the signal spectra shown in FIG. 3, section (d).

FIG. 13 displays the real and imaginary parts of the Raman susceptibility, normalized to the frequency-independent electronic susceptibility.

### DETAILED DESCRIPTION OF THE EMBODIMENTS

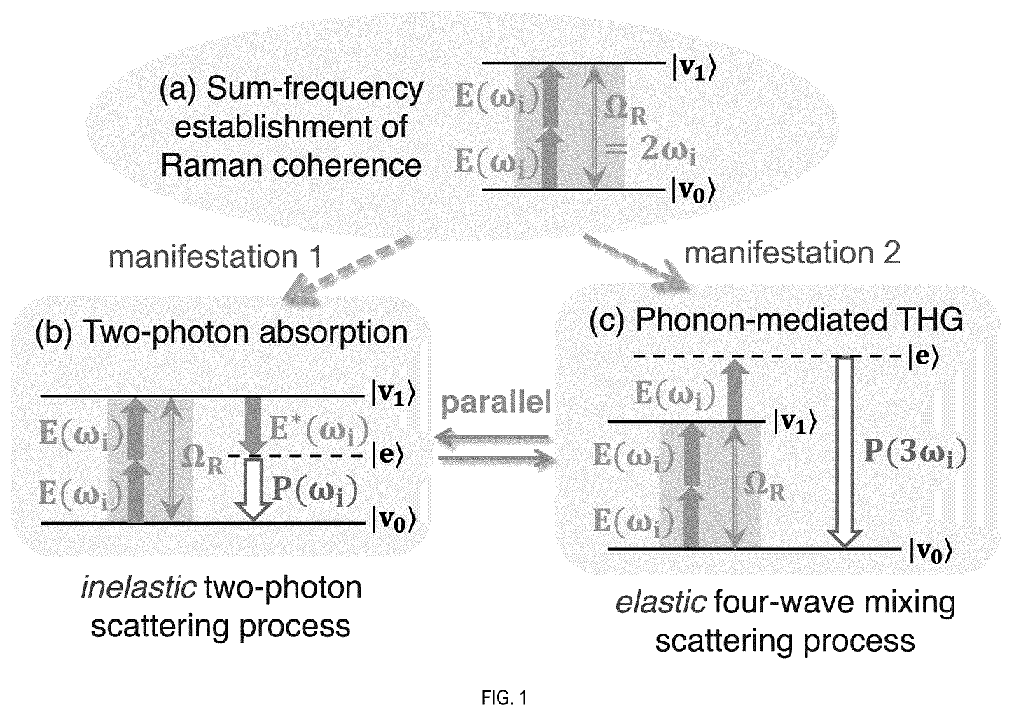

Herein we disclose a third-harmonic generation (THG) process enhanced by the intermediate Raman coherence, which we refer to as phonon-mediated THG (PM-THG) (FIG. 1(c)). Just as TPA relates to SRS, PM-THG differs from coherent anti-Stokes Raman scattering (CARS), with Raman coherence established by a sum-frequency pathway rather than the conventional difference-frequency pathway. When the applied fields are degenerate, the ‘anti-Stokes’ frequency, ωₐ=ωᵢ+Ω_{R}, is equivalent to the third harmonic of the incident laser frequency, 3ωᵢ. Like CARS, PM-THG is an elastic four-wave mixing process where the Raman coherence increases the optical scattering cross-section where, in embodiments, all incident energy is returned to the optical fields. Note that TPA and PM-THG, as different manifestations of SFE of Raman coherence, are parallel processes that occur simultaneously.

Leveraging the sufficiently narrow bandwidth and high peak intensity of a home-built picosecond THz source, we present the first experimental demonstration and theoretical analysis of PM-THG in solid-state systems, showcasing attributes distinct from those previously observed in molecular systems. Embodiments herein include PM-THG in diamond, a photonic material without IR-active phonons. As PM-THG in diamond is highly sensitive to field polarization, the contributions of the purely electronic and phonon-mediated pathways to THG near resonance may be disentangled. This allows detection of a remarkable THG enhancement by over 100-fold at resonance that may be further extended to 3000-fold. Moreover, a study of frequency dependence uncovers a new phenomenon, the suppression of THG above resonance due to out-of-phase purely electronic and phonon-mediated contributions to the polarization field, allowing a six-order-of-magnitude tuning range of the THG efficiency. These observations thus illuminate new opportunities for strongly linked structural and optical property modification of crystals with light at low (THz/mid-infrared) frequencies. This has relevance both to photonics applications as a strongly enhanced or suppressed solid-state optical wave-mixing nonlinearity, and to condensed-phase physics as a new method for detecting structural dynamics during light-driven material phase control and for spectroscopy in the THz regime. We reiterate that in both cases, the relevance is not only to diamond, but to all solids with Raman-active phonons.

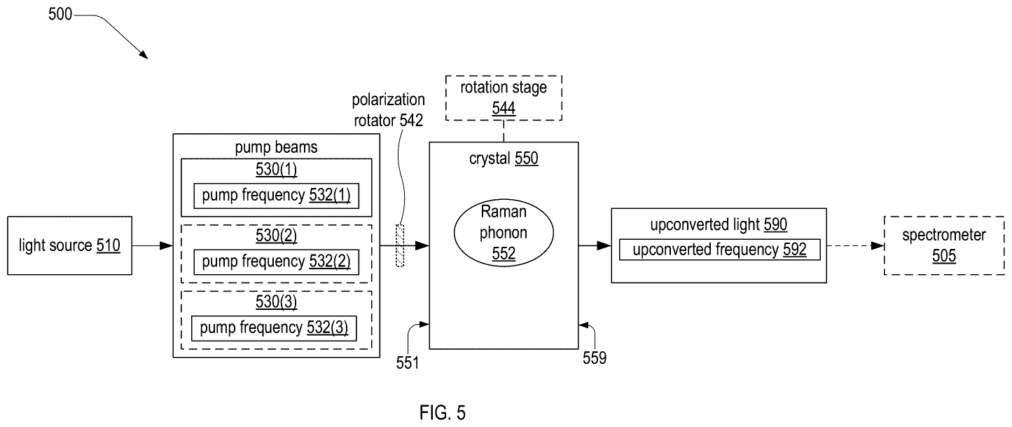

Embodiments employed an 80-μm thick type-IIa high-purity diamond crystal plate (nitrogen content <1 ppm) with [001] orientation grown by microwave plasma chemical vapor deposition. This crystal plate is an example of crystal 550, FIG. 5. We focus on the sole Raman-active optical phonon of diamond with F_{2g} symmetry. We determined the phonon resonant frequency (f_{R}=Ω_{R}/2π=39.1352±0.002 THz) and linewidth (F/2π=0.056±0.003 THz) using a confocal Raman microscope, and found them to be consistent with previous reports (see section entitled Raman Microscopy Measurements). To increase coherent growth of the third-harmonic field, the 80-μm sample thickness was chosen to match the THG coherence length, L_{coh}=|π/[3ωᵢ(n(ωᵢ)−n(3ωᵢ))]|, where c is the speed of light and n is the refractive index.

Embodiments of PM-THG employs an applied laser frequency fᵢ at half the phonon frequency, which may be approximately 20 THz. We used a home-built tabletop tunable THz source with <0.5 THz full-width at half-maximum (FWHM) bandwidth. This bandwidth ensures that a large fraction of the laser power is directed toward Raman-active phonon excitation, which is important for observing strong PM-THG. This THz source combines adiabatic difference frequency generation with programmable pulse shaping to generate THz pulses with customizable bandwidth and central frequency continuously tunable from 14 to 37 THz.

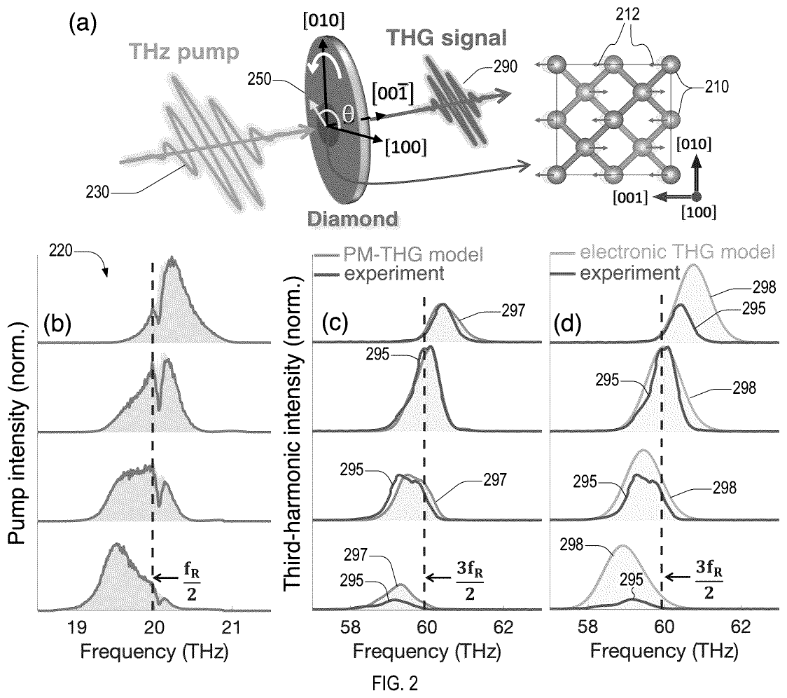

Section (a) of FIG. 2 shows a pump beam 230 incident on a crystal 250, which produces an upconverted beam 290. Section (a) also shows orientations of field polarizations of beams 230 and 290, and in an embodiment when crystal 250 is diamond, crystal axes, and F_{2g} phonon. Arrows 212 depict motion of carbon atoms 210 in a phonon oscillation. In the example of section (a), beams 230 and 290 are linearly polarized at an angle θ with respect to the [100] crystal axis of crystal 250.

Section (b) of FIG. 2 shows, for the aforementioned diamond embodiment, example measured spectral intensities 220 of the THz pump beam 230. For the same embodiment, sections (c) and (d) show example measured THG intensities 295 compared to theoretical predictions 297 from the PM-THG model and predictions 298 from an electronic THG model, uniformly normalized across rows such that theoretical and experimental maxima match in the second row.

In embodiments, a 15-mm focal length lens focuses the THz pump onto the diamond sample, resulting in a maximum fluence of 13 mJ/cm² (˜1-ps pulse duration and up to 1.5-J pulse energy at a 10 kHz repetition rate). Rotation of the diamond plate allowed the electric field of the linearly polarized pump to align parallel to any angle θ in the [100]-[010] crystal plane (section (a) of FIG. 2). Emitted light was collimated by a lens and passed through two windows to block the THz pump before passing into a spectrometer. The THz generation stage and the path of the THz beam until reaching the diamond plate were purged by gas to reduce absorption from in air.

We observed a sharp increase in emitted light at the third-harmonic of the incident frequency, 3fᵢ, and its strong sensitivity to the pump frequency and polarization angle in the vicinity of the resonant condition (fᵢ=f_{R}/2=19.98 THz). Section (b)-(d) of FIG. 2 show the incident pump and emitted third-harmonic spectra, obtained with the crystal plate oriented to maximize the observed THG power. The pump central frequencies were adjusted within a range close to resonance of 19.6-20.4 THz.

To corroborate the phonon-mediated origin of the observed THG spectra, we compare them to models based on solely phonon-mediated or purely electronic pathways. For low-frequency fields in diamond, the third-order electric polarization has two components at lowest order,

$$\begin{matrix}{P}^{( 3 )} ( t ) = {χ}_{e}^{( 3 )} E ( t ) E ( t ) E ( t ) + Π {Q}_{R} ( t ) E ( t ) \\ ≡ {P}_{e}^{( 3 )} ( t ) + {P}_{R}^{( 3 )} ( t ) .\end{matrix} \qquad ( 1 )$$

The first term Pₑ⁽³⁾(t) is the origin of non-resonant electronic THG, where χₑ⁽³⁾ is the approximately instantaneous third-order electronic susceptibility arising from the anharmonic electronic potential. The second term, P_{R}⁽³⁾(t), is the product of the incident electric field E(t) and the Raman-active phonon displacement Q_{R}(t), describing the origin of PM-THG. The phonon dynamics may be modeled as a classical Lorentzian oscillator with equation of motion

$$M ( {\ddot{Q}}_{R} + 2 Γ {\dot{Q}}_{R} + {Ω}_{R}^{2} {Q}_{R} ) = {Π}_{αβ} {E}_{α} {E}_{β} , \qquad ( 2 )$$

where M is the phonon effective mass. The phonon-to-electric-field coupling originates from the dependence of the linear electronic susceptibility χₑ⁽¹⁾ on Q_{R}, given by the Raman polarizability tensor Π. For pump field propagating along the diamond [001] axis and polarized at an angle θ, such that \vec{E}(t)=E(t)[cos θ sin θ 0] with θ=0° corresponding to the [100] direction, this second-rank tensor takes the form [3],

$$Π = \frac{\partial {χ}_{e}^{( 1 )}}{\partial {Q}_{R}} {\vert}_{{Q}_{R} = 0} = {Π}_{0} ( \begin{matrix}0 & 1 & 0 \\ 1 & 0 & 0 \\ 0 & 0 & 0\end{matrix} ) .$$

We solve Eqs. 1, 2 in the frequency domain and derive the Fourier transforms of Pₑ⁽³⁾(t) and P_{R}⁽³⁾(t) when E(t) is polarized along the [110] axis (see Appendix D for details):

$${\tilde{P}}_{e}^{( 3 )} ( ω ) = [ {χ}_{e}^{( 3 )} ( \tilde{E} ( ω ) * \tilde{E} ( ω ) ) ] * \tilde{E} ( ω ) , \qquad ( 3 )$$

$$\begin{matrix}{\tilde{P}}_{R}^{( 3 )} ( ω ) = {Π}_{0} {\tilde{Q}}_{R} ( ω ) * \tilde{E} ( ω ) \\ = [ {χ}_{R}^{( 3 )} ( ω ) ( \tilde{E} ( ω ) * \tilde{E} ( ω ) ) ] * \tilde{E} ( ω ) .\end{matrix} \qquad ( 4 )$$

\tilde{E}(ω), \tilde{Q}_{R}(ω) are the Fourier transforms of E(t), Q(t), and * denotes linear convolution. We defined a Raman susceptibility in Eq. 4,

$${χ}_{R}^{( 3 )} ( ω ) = {Π}_{0}^{2} / M ( {Ω}_{R}^{2} - {ω}^{2} - 2 i Γω ) . \qquad ( 5 )$$

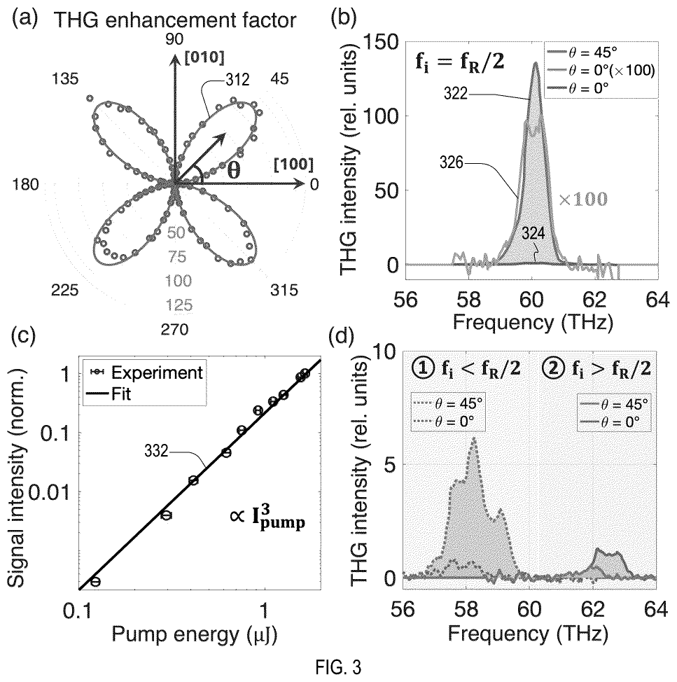

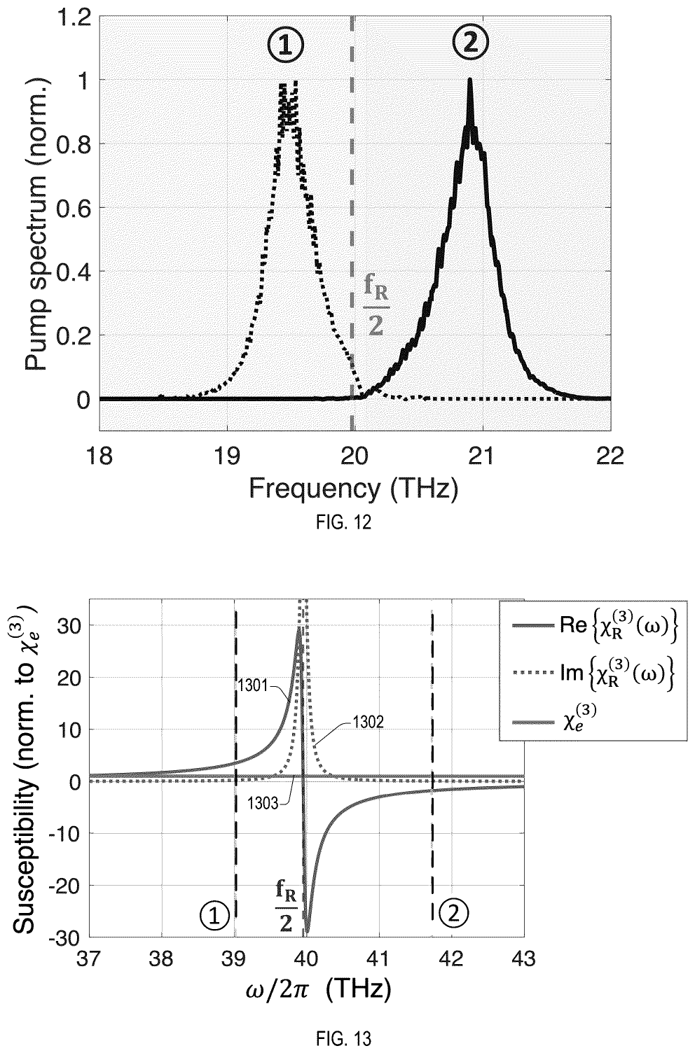

FIG. 3 includes plots (a)-(d). Plot (a) is polar plot of the THG power enhancement factor (circles) vs. pump polarization angle θ with pump centered at resonance, with best fit to 113 sin²(2θ) (curve 312). Plot (b) is a THG signal spectra observed at θ=450 (curve 322) and 0° (curve 324 for actual intensity, curve 326 for intensity magnified by 100). Plot (c) shows signal intensity dependence on pump energy at θ=450 (log-log scale), with a line 332 of slope 3 for reference. Plot (d) shows THG signal spectra observed at θ=45° and 0° for pump frequencies below (dotted lines) and above (solid lines) resonance, with corresponding pump spectra shown in FIG. 12. All the signal spectra in (b) and (d) are normalized to the maximum signal intensity at θ=0° in (b).

To compare the measurements against theory, we incorporated the pump spectra (Section (b) of FIG. 2) into our theoretical model, and calculated signal spectra corresponding to the PM-THG (FIG. 2, section (c), predictions 297) and electronic-THG (FIG. 2, section (d), predictions 298) mechanisms acting independently.

A consistent dip at 20.1 THz in pump spectra resulted from absorption along the spectrometer measurement path that was impractical to purge with N₂. To remove this artifact, a Lorentzian absorption model was used to estimate the true pump spectrum at the diamond crystal (Section (b) of FIG. 2, shaded region).

While the PM-THG model reproduces both the experimental trend in signal intensity and spectral shape, the electronic-THG model predicts a signal intensity lacking sensitivity to pump frequency and a broader signal spectrum centered further from resonance than the measurement. The differences between the theoretical predictions may be understood through the form of the nonlinear polarization (Eq. 3 vs. Eq. 4), whereby PM-THG contains an implicit convolution between the frequency-dependent Raman coherence \tilde{Q}_{R} (ω) and \tilde{E}(ω), but purely electronic THG involves only a double autoconvolution of \tilde{E}(ω).

Next, by investigating the dependence of the THG power (integrated power spectrum) on pump polarization angle θ (introduced in Section (a) of FIG. 2, we can both distinguish the relative contributions of the purely electronic and phonon-mediated pathways and reveal interference effects in the total third-order polarization. Section (a) of FIG. 3 summarizes THG power dependence on pump polarization with the pump frequency fᵢ centered at the f_{R}/2 resonance. The radial coordinate represents the ratio of third-harmonic signal power to the average of its minima found at θ=0°, 90°, 180°, and 270°. Strong maxima, exceeding one hundred, are observed at θ=45°, 135°, 2250 and 315°. Section (b) of FIG. 3 compares the signal spectra at θ=450 and θ=0°. Following the theoretical discussion above, the amplitude of Raman oscillation Q_{R}∝ sin(2θ). As the experimental data in FIG. 3 (section (a)) is observed to fit closely to a sin²(2θ) function (curve 312), we can thus infer that the signal intensity is dominated by the phonon-mediated contribution to the third-order polarizability, |P⁽³⁾|²∝|Q_{R}|².

The non-resonant electronic contribution, in contrast, exhibits near θ-independence, as determined by the χₑ⁽³⁾ tensor of diamond crystal [5] (see section entitled “Pump Polarization dependence analysis of THG signal intensity”). Thus, the minimal signal observed at θ=0° and 90° originates only from the purely electronic pathway, allowing interpretation of the data in section (a) of FIG. 3 as a THG ‘enhancement factor’ relative to the purely electronic effect. A best fit of 113 sin²(2θ) to this data indicates that the phonon-mediated pathway enhances THG intensity by at least a factor of 113.

Section (c) of FIG. 3 shows the dependence of the third-harmonic signal intensity on incident pump energy at θ=45°. On a log-log scale, the data fits well to a line of slope 3, confirming a THG process as the signal origin and indicating a largely-undiminished THz pump and unsaturated phonon oscillation amplitude. This allows interpretation of the measured THG enhancement factor as |(P_{R}⁽³⁾+Pₑ⁽³⁾)/Pₑ⁽³⁾|², from which we deduce a susceptibility ratio at resonance |χ_{R}⁽³⁾(Ω_{R})/χₑ⁽³⁾)≳58 (see Appendix D).

Sections (a) and (b) of FIG. 3 demonstrate the dominance of the PM-THG pathway with a resonant pump. However, detuning the pump frequency reveals a more complex THG phenomenon. As section (d) of FIG. 3 shows, for a pump with central frequency fᵢ<f_{R}/2, the THG intensity observed at θ=450 exceeds that at θ=0° by only a factor of 10, a magnitude smaller than the enhancement observed at resonance. Remarkably, for pump central frequency fᵢ>f_{R}/2, the THG intensity at θ=45° is suppressed below that at θ=0°. This indicates destructive interference between the phonon-mediated and electronic pathways, resulting in a total THG intensity lower than that from the purely electronic contribution alone.

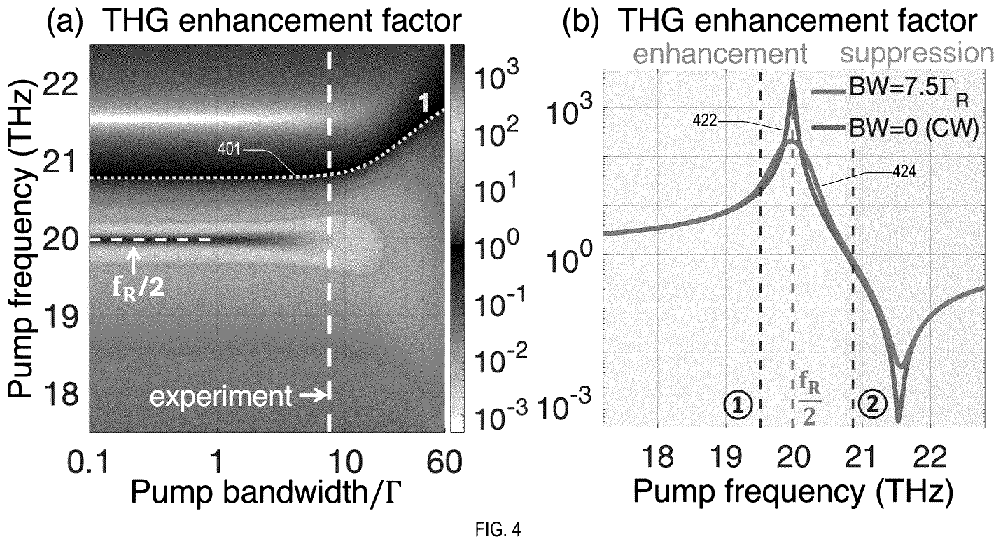

Section (a) of FIG. 4 shows a THG enhancement factor as a function of pump central frequency and bandwidth, spanning from >10³ to <10⁻³. A dotted contour line 401 (enhancement factor=1) divides the figure into two regions: THG enhancement (below) and suppression (above). Section (b) of FIG. 4 shows a THG enhancement factor vs. pump central frequency for a continuous-wave (CW) pump (curve 422) and a Gaussian-shape pump with a bandwidth of 7.5Γ (curve 424), simulating our experimental conditions. The shading indicates THG enhancement and suppression regions respectively. Dashed lines \textcircled{1} and \textcircled{2} mark pump central frequencies corresponding to the signal and in FIG. 3, section (d).

To explore this possibility, we calculate the THG enhancement factor, |(P_{R}⁽³⁾+Pₑ⁽³⁾)/Pₑ⁽³⁾|², using Eqs. 3,4 and the obtained susceptibility ratio |χ_{R}⁽³⁾(Ω_{R})/χₑ⁽³⁾)|=58. Section (a) of FIG. 4 plots our results against pump central frequency and FWHM bandwidth. We observe several notable features. First, on resonance (fᵢ=f_{R}/2), a much larger enhancement is possible than in our experiment. In embodiments, as in our experiment, the pump's bandwidth (i.e., its spectral width, marked by the vertical dashed line in section (a) of FIG. 4) is approximately 7.5 times wider than the Raman mode linewidth Γ, as this resulted in an enhancement factor >100 on resonance. The bandwidth of pump beam 530, FIG. 5, may have such a pump bandwidth.

In embodiments, pump bandwidths are narrower than 2.4Γ (corresponding to FWHM pulse durations >3.3 ps, potentially achievable leveraging chirped-pulse difference-frequency generation (DFG) or DFG quantum cascade lasers), the enhancement factor can surpass 10³. This demonstrates the remarkable potential of lattice vibrations to modify the optical properties of crystals. In contrast, for a broader pump bandwidth of 60Γ (corresponding to 130-fs pulse duration), the predicted enhancement factor falls to approximately five.

Second, while the THG enhancement factor drops rapidly as the pump central frequency deviates from resonance (f_{R}/2) as expected, this decline is faster with frequency detuning above f_{R}/2 than below it, eventually reaching a region with an enhancement factor less than one. Dotted contour line 401, denoting a factor of 1, thus divides section (a) of FIG. 4 into two regions: THG enhancement (below) and suppression (above). This trend is further illustrated by section (b) of FIG. 4, showing the frequency-dependent enhancement factor for a continuous-wave pump and a pump with a bandwidth of 7.5Γ, which simulates our experimental conditions. Suppression occurs when the pump central frequency is detuned beyond 20.8 THz. The pump frequencies corresponding to the signal shown in section (d) of FIG. 3, marked by lines \textcircled{1} and \textcircled{2}, lie within the regions of enhancement (<20 THz) and suppression (>20 THz) respectively. For a pump bandwidth significantly narrower than the Raman linewidth, the total THG intensity may be suppressed to below 10⁻³ times that of the purely electronic pathway at a pump frequency of ˜21.5 THz.

This nearly full cancellation of the nonlinear polarization fields contributed by the phonon-mediated and electronic pathways is explained by the opposite signs of χₑ⁽³⁾ and the real part of χ_{R}⁽³⁾(ω) above resonance (see Appendix E). Our first demonstration of this phenomenon in THG thus illustrates the correspondence between optical scattering physics in the THz domain via SFE of Raman coherence and those via traditional difference-frequency excitation with high-frequency light.

In summary, we demonstrate strong anisotropic third-harmonic generation in diamond mediated by resonant sum-frequency driving of Raman-active phonons with THz light. The observed pump frequency and polarization dependence of the signal confirms the dominant role of PM-THG over purely electronic THG at half the Raman resonance. This polarization dependence—distinctive to condensed systems (e.g., crystalline solids)—allows the phonon-mediated and purely electronic contributions to be resolved. At resonance, we observed over 100-fold enhancement in THG efficiency, and predict over 3000-fold enhancement for narrower-bandwidth pumping. This corresponds to a nonlinear susceptibility of PM-THG surpassing that of purely electronic THG by over 58 times at resonance. Moreover, we have discovered THG suppression above resonance, a result of destructive interference between phonon-mediated and purely electronic contributions to the polarization field. These findings highlight the intimate tie between the nonlinear optical response and the structural response in solids, with timely relevance to several fields of research.

From a photonics perspective, PM-THG adds new capabilities to materials platforms through the large enhancement and control of optical coefficients enabled by Raman-active phonons. The strong dependence of the THG efficiency on pump polarization direction and frequency (at least six orders of magnitude) may be applied to infrared nonlinear optical switching and orientation diagnostics.

The phonon-mediated pathway may also allow higher-order (e.g., 5^{th}, 7^{th}, 9^{th}) harmonic generation processes to become efficient, potentially bridging the incident field near 20 THz to the telecommunications range. Beyond PM-THG, non-degenerate instances of phonon-mediated four-wave mixing may be employed. For example, applying two THz frequencies with a sum-frequency beat note slightly detuned from Ω_{R} might induce significant cross-phase modulation, markedly affecting the refractive indices of the incident fields.

Of significance to the light-driven structural control of quantum materials, our report clarifies that PM-THG and TPA are parallel optical polarization effects—elastic and inelastic, respectively—that both accompany THz sum-frequency driving of Raman-active phonons in crystals. Our findings demonstrate the potential of Raman-active phonons to induce marked changes in the optical properties of solids. Moreover, the duality of structural and optical responses in materials allows PM-THG to serve as a convenient marker of concurrent structural changes during light-driven phase transitions. The temporal evolution of the coherent phonon amplitude might be resolved by applying a pump and a subsequent time-delayed pump at the same frequency of f_{R}/2 with a small angular separation, and detecting the resulting noncollinear PM-THG signal. This technique eliminates the requirement for carrier-envelope-phase stable THz pump pulses. Thus, beyond its value as a strong nonlinear optical response, PM-THG offers a powerful laser-lab-scale diagnostic for the growing field of light-driven structural control in condensed matter physics.

In an embodiment there is a time delay used between the pump beams that excite the Raman phonon and the pump beam that is upconverted. This may be used to either (i) modulate the output intensity or (ii) detect the lifetime of the Raman phonon coherence (a spectroscopy method).

Applications stemming from these embodiments result from the enhancement of third-harmonic generation (or more general sum-frequency generation involving the addition of frequencies of three applied fields) resulting from the satisfaction of resonance conditions. Choice of a particular Raman-active phonon mode may be made based on considerations both in terms of material and laser properties.

Background on the origin of the light-matter interaction facilitates understanding of these considerations. The equation of the third-order polarization term contributed by Raman phonons is: P_{R}⁽³⁾=Π₀Q_{R}E. The amplitude of the Raman response Q_{R} is determined by solution of eq (6).

$$M ( {\ddot{Q}}_{R} + 2 Γ {\dot{Q}}_{R} + {Ω}_{R}^{2} {Q}_{R} ) = {Π}_{αβ} {E}_{α} {E}_{β} \qquad ( 6 )$$

Raman response Q_{R} depends on both the material properties, dictated by the intrinsic characteristics of the Raman mode Q_{R}, which include Raman tensor coefficient (Π₀), the mass of the phonon mode (M), the phonon mode linewidth (Γ), the phonon resonant frequency Ω_{R}. Raman response Q_{R} also depends on the relative frequency and the polarization direction of the incident light, and the properties of the applied electric fields, E_{α} and E_{β}, such as bandwidth, frequency, and polarization.

There are two main perspectives by which we might evaluate the appropriateness of a Raman-active phonon mode. The first is in terms of the material properties only, and is the evaluation of the magnitude of the third-order Raman susceptibility at resonance. The maximum THG enhancement factor induced by a given Raman mode is equal to the square of the corresponding third-order Raman susceptibility at resonance (see Eq. 5): |χ⁽³⁾_{R}(Ω_{R})|²=Π₀²/2MΓΩ_{R}|²

From this expression, one can see what contributes to a large THG enhancement factor results from at least one of the following: a large Raman tensor coefficient Π₀, a small phonon mode mass M, a narrow phonon mode linewidth Γ, and a small phonon resonant frequency Ω_{R}

However, for a given application, one may not narrow the phonon mode linewidth and/or the small phonon resonant frequency. This brings us to the second perspective, which has to do with matching the phonon mode properties to the laser properties of the application. The list of possible considerations here are as follows.

In embodiments, to meet the resonance condition, for a given set of laser frequencies ω₁, ω₂, ω₃, there is a combination ωᵢ+ωⱼ or 2ωᵢ that equals the phonon resonant frequency Ω_{R}. In embodiments, to make use of the resonance, a phonon mode linewidth Γ that matches the bandwidth of the convolution of the two laser fields with frequencies that are adding to the phonon resonant frequency Ω_{R}, which are E_{α}, E_{β} in the equation above. When the laser fields have a broad bandwidth, this means that having a narrow phonon mode linewidth Γ is not necessarily best.

In embodiments, to produce a large amplitude of the driven Raman mode, the product of the Raman tensor with the two applied fields does not vanish (e.g., equal zero) due to symmetry constraints. Hence, in such embodiments, the Raman-active phonon mode has nonzero tensor element Π_{αβ} for the field polarizations of the applied fields involved in driving the phonon, which are α and β.

FIG. 5 is a functional block diagram of a phonon-mediated sum-frequency generator 500, hereinafter generator 500. Generator 500 includes a light source 510 and a crystal 550. Generator 500 may be a light source for an optical instrument, such as spectrometer 505 shown in FIG. 5. Generator 500 may be part of spectrometer 505.

Crystal 550 has an input face 551 and an output face 559 opposite input face 559. Output face 559 may be parallel to input face 551, and at least one of face 551 and 559 may be parallel to a crystal plane of crystal 550.

Light source 510 may include one or more lasers, such a terahertz laser, which may be a pulsed laser. Light source 510 outputs pump beams 530, which includes pump beam 530(1) and may also include additional pump beams, such as one or more of pump beams 530(2) and 530(3). Pump beams 530 may be linearly polarized and propagating perpendicular to a [100]-[010] crystal plane of crystal 550. At least two of pump beams 530(1-3) may be copropagating and may be incident on input face 551.

Each pump beam 530 has a pump frequency 532. Pump frequency 532 may be in the terahertz region or mid-infrared region of the electromagnetic spectrum. THz pump beam 230 is an example of pump beam 530.

Pump beams 530 illuminate crystal 550, thereby exciting a Raman phonon 552 in crystal 550. Continued illumination of crystal 550 by pump beams 530 while Raman phonon 552 is at least partially excited results in the generation of an upconverted beam 590. In embodiments, Raman phonon 552 at least one of (i) has F_{2g} symmetry, is an optical phonon, and is infrared-inactive. The bandwidth of pump beam 530 may be wider than the Raman mode line width associated with Raman phonon 442 by a factor β, where β may be less than ten. For example, β may be between two and eight, which can achieve a high THG enhancement factor as discussed in the description of FIG. 4. In other embodiments, factor β may be larger, such as between ten and sixty.

Upconverted beam 590 has an upconverted frequency 592. Upconverted beam 290 is an example of upconverted beam 590. When upconverted frequency 592 equals three times pump frequency 532, the sum frequency is the third harmonic, such that generator 500 is a phonon-mediated third-harmonic generator. One or more of pump beams 530 may be pulsed, in which case upconverted beam 590 may also be a pulsed beam. Upconverted beam 590 may exit crystal 550 via output face 559.

Generator 500 may also include one or both of a polarization rotator 542 and a rotation stage 544 for changing angle between a crystal axis of crystal 550 and a polarization orientation of pump beams 530, thereby modulating the amplitude of upconverted beam 590. Polarization rotator 542 rotates and/or changes the polarization state of pump beams 530 (e.g., polarization angle θ shown in FIG. 2). Polarization rotator 542 may include a half-wave plate. Rotation stage 544 rotates crystal 550, e.g., about an axis perpendicular to a crystal plane of crystal 550.

In embodiments, one of pump beams 530 is a carrier signal modulated by an information-bearing signal, which results in upconverted beam 590 also being modulated by the information-bearing signal. In such embodiments, upconverted beam 590 functions as a new carrier signal.

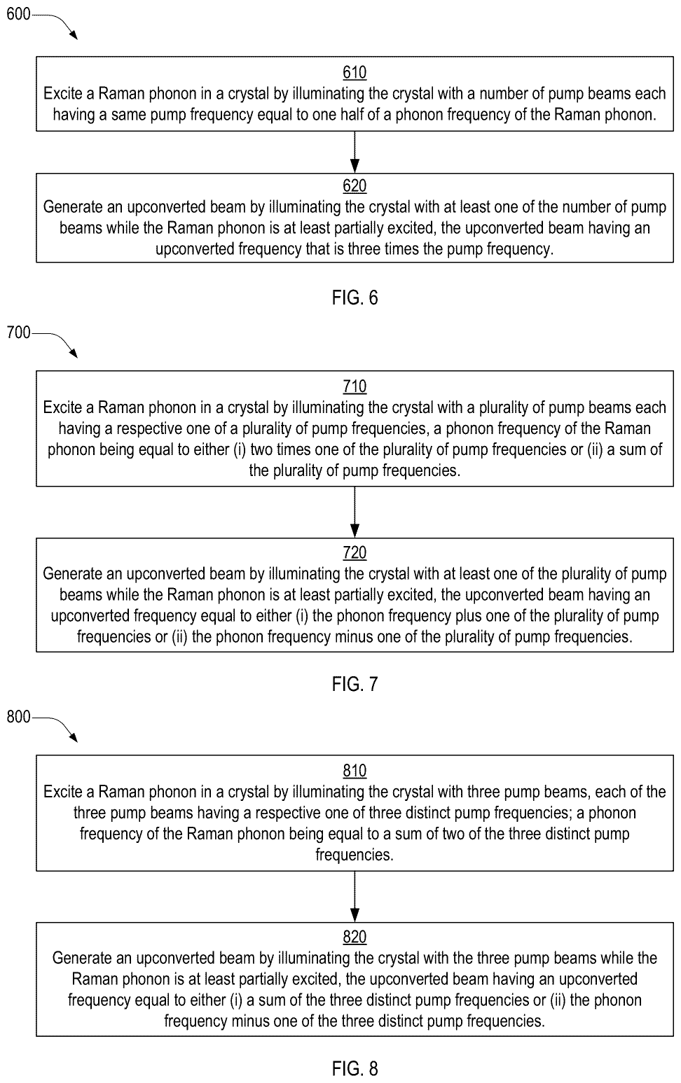

FIGS. 6, 7, and 8 are flowcharts illustrating phonon-mediated upconversion methods 600, 700, and 800, respectively. Each of methods 600, 700, and 800 may be implemented by one or more aspects of phonon-mediated sum-frequency generator 500. The following descriptions of methods 600, 700, and 800 includes parenthetical numbers following terms used in a method step. The parenthetical number indicates that the element associated with the number in parenthesis is an example of the term. For example, the description of step 610 below recites “exciting a Raman phonon (552) in a crystal (550),” which means that Raman phonon 552 and crystal 550 are respective examples of the Raman phonon and crystal introduced in step 610.

Method 600 includes steps 610 and 620. Step 610 includes exciting a Raman phonon (552) in a crystal (550) by illuminating the crystal with a number of pump beams (530) each having a same pump frequency (532) equal to one half of a phonon frequency of the Raman phonon. The number of pump beams may equal one, two, or three.

Step 620 includes generating an upconverted beam (590) by illuminating the crystal with at least one of the number of pump beams while the Raman phonon is at least partially excited. The upconverted beam having an upconverted frequency (592) that is three times the pump frequency. The at least one of the number of pump beams may include each of the number of pump beams.

Method 700 includes step 710 and 720. Step 710 includes exciting a Raman phonon (552) in a crystal (550) by illuminating the crystal (550) with a plurality of pump beams (530) each having a respective one of a plurality of pump frequencies (532). A phonon frequency of the Raman phonon is equal to either (i) two times one of the plurality of pump frequencies or (ii) a sum of the plurality of pump frequencies. In embodiments, the plurality of pump beams consisting of two pump beams or three pump beams. One or more of the plurality of pump frequencies may be in the terahertz or mid-infrared regions of the electromagnetic spectrum.

Step 720 includes generating an upconverted beam (590) by illuminating the crystal with at least one of the plurality of pump beams while the Raman phonon is at least partially excited. The upconverted beam has an upconverted frequency (592) equal to either (i) the phonon frequency plus one of the plurality of pump frequencies or (ii) the phonon frequency minus one of the plurality of pump frequencies. The at least one of the plurality of pump beams including each of the plurality of pump beams.

Method 800 includes step 810 and 820. Step 810 includes exciting a Raman phonon (552) in a crystal (550) by illuminating the crystal with three pump beams (530). Each of the three pump beams has a respective one of three distinct pump frequencies (532). A phonon frequency of the Raman phonon equals to a sum of two of the three distinct pump frequencies. One or more of the three distinct pump frequencies may be in the terahertz region or mid-infrared region of the electromagnetic spectrum.

Step 820 includes generating an upconverted beam (590) by illuminating the crystal with the three pump beams while the Raman phonon is at least partially excited, the upconverted beam having an upconverted frequency (592) equal to either (i) a sum of the three distinct pump frequencies or (ii) the phonon frequency minus one of the three distinct pump frequencies.

Any of methods 600, 700, and 800 may include modulating the intensity of the upconverted beam by changing an angle between (i) a plane of polarization of at least one of the number of pump beams and (ii) a crystal axis of the crystal. Said step of modulating the intensity may be executed while the Raman phonon is at least partially excited.

### Derivation of PM-THG and TPA

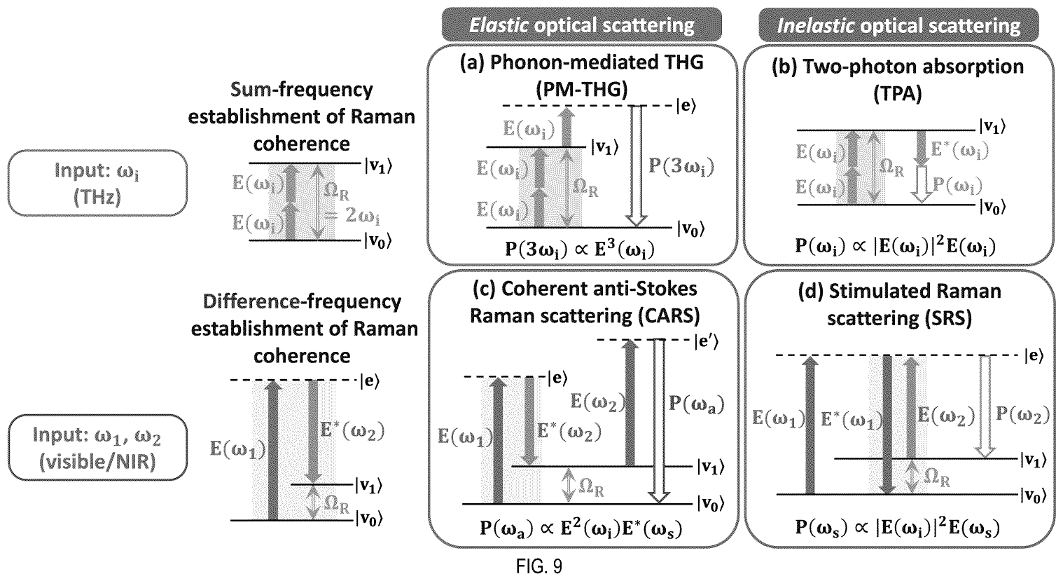

FIG. 9 compares of Raman coherence establishment and associated optical effects via sum-frequency and difference-frequency pathways. Top row: Sum-frequency driving of Raman coherence using a single THz incident field at ωᵢ=Ω_{R}/2, leading to (a) an elastic optical scattering effect, PM-THG, and (b) an inelastic optical scattering effect, TPA. Bottom row: Conventional difference-frequency driving of Raman coherence using two high-frequency light fields at ω₁ and ω₂=ω₁−Ω_{R}, resulting in (c) an elastic optical scattering effect, CARS, and (d) an inelastic optical scattering effect, SRS. |v₀ [symbol] , |v₁ [symbol] are ground and excited states of a Raman-active phonon. |e [symbol] , |e′ [symbol] are virtual electronic excited states.

When the pump field \vec{E} is polarized along θ=450 (the [110] axis of crystal), the phonon-mediated third-order polarization, \vec{P}_{R}, as defined in Eq. 1 of the main text, is parallel to E (refer to Appendix C for detailed analysis of polarization direction dependence). Therefore, in this section, we write \vec{E} and \vec{P}_{R}⁽³⁾ in scalar form to simplify the analysis,

$${P}_{R}^{( 3 )} ( t ) = {Π}_{0} {Q}_{R} ( t ) E ( t ) . \qquad ( A1 )$$

We assume E(t) is monochromatic light in the THz range with frequency ωᵢ=Ω_{R}/2, E(t)=(ωᵢ)e^{-iω}^{ᵢ}^{t}+c.c. The Raman-active phonon Q_{R} is driven by two force terms with the sum-beat and difference-beat frequencies of the pump field respectively:

$$\begin{matrix}M ( {\ddot{Q}}_{R} + 2 Γ {\dot{Q}}_{R} + {Ω}_{R}^{2} {Q}_{R} ) = {Π}_{0} E ( t ) E ( t ) \\ = {Π}_{0} ( {E}^{2} ( {ω}_{i} ) {e}^{- i 2 {ω}_{i} t} + {\vert E ( {ω}_{i} ) \vert}^{2} + c . c . )\end{matrix} \qquad ( A2 )$$

The first term, with a frequency of 2ωᵢ=Ω_{R}, resonantly drives the Raman-active phonons. The second term represents a unidirectional force driving at zero frequency, which may be disregarded here due to its contribution being overshadowed by the resonant term. Therefore, the steady-state solution of Eq. A2 is Q_{R}(t)=Q_{R}(2ωᵢ)e^{-i2ω}^{ᵢ}^{t}+c.c., where

$${Q}_{R} ( 2 {ω}_{i} ) = \frac{{Π}_{0}}{M [ {Ω}_{R}^{2} - {( 2 {ω}_{i} )}^{2} - 2 i Γ ( 2 {ω}_{i} ) ]} {E}^{2} ( {ω}_{i} ) . \qquad ( A3 )$$

By substituting Q_{R} into Eq. A1, we obtain two frequency components of P_{R}⁽³⁾(t), one at 3ωᵢ and the other at the pump frequency, ωᵢ.

$${P}_{R}^{( 3 )} ( t ) = {P}_{R}^{( 3 )} ( 3 {ω}_{i} ; {ω}_{i} , {ω}_{i} , {ω}_{i} ) {e}^{- i 3 {ω}_{i} t} + {P}_{R}^{( 3 )} ( {ω}_{i} ; {ω}_{i} , {ω}_{i} , - {ω}_{i} ) {e}^{- i {ω}_{i} t} + c . c . \qquad ( A4 )$$

$$where$$

$$\begin{matrix}{P}_{R}^{( 3 )} ( 3 {ω}_{i} ; {ω}_{i} , {ω}_{i} , {ω}_{i} ) = {Π}_{0} {Q}_{R} ( 2 {ω}_{i} ) E ( {ω}_{i} ) \\ = {χ}_{R}^{( 3 )} ( 2 {ω}_{i} ≃ {Ω}_{R} ) E ( {ω}_{i} ) E ( {ω}_{i} ) E ( {ω}_{i} )\end{matrix} \qquad ( A5 )$$

represents the origin of PM-THG, with the Raman susceptibility given by

$${χ}_{R}^{( 3 )} ( 2 {ω}_{i} ≃ {Ω}_{R} ) = \frac{{Π}_{0}^{2}}{M [ {Ω}_{R}^{2} - {( 2 {ω}_{i} )}^{2} - 2 i Γ ( 2 {ω}_{i} ) ]} . \qquad ( A6 )$$

The other polarization term at the incident frequency is

$$\begin{matrix}{P}_{R}^{( 3 )} ( {ω}_{i} ; {ω}_{i} , {ω}_{i} , - {ω}_{i} ) = {Π}_{0} {Q}_{R} ( 2 {ω}_{i} ) {E}^{*} ( {ω}_{i} ) \\ = {χ}_{R}^{( 3 )} ( 2 {ω}_{i} ≃ {Ω}_{R} ) {\vert E ( {ω}_{i} ) \vert}^{2} E ( {ω}_{i} )\end{matrix} , \qquad ( A7 )$$

which leads to a TPA process because χ_{R}⁽³⁾(2ωᵢ≃Ω_{R}) is a pure positive imaginary at the Raman resonance (see FIG. 13). Therefore, the pump field E(t) experiences a nonlinear absorption at a rate proportional to its intensity |E(ωᵢ)|².

TABLE I
Summary of characteristics of PM-THG, TPA, CARS, and SRS.

| | | | Sum/Difference- | | |
|---|---|---|---|---|---|
| | Input | | frequency | Elastic/ | |
| Effect | beam | Frequency range | pathway | Inelastic | Third-order polarization term |
| PM- | ωᵢ | THz (≈Ω_{R}/2) | sum | elastic | P_{R}⁽³⁾(3ωᵢ) = χ_{R}⁽³⁾(2ωᵢ ≃ Ω_{R}E³(ωᵢ) |
| THG | | | | | |
| TPA | ωᵢ | THZ (≈Ω_{R}/2) | sum | inelastic | P_{R}⁽³⁾(3ωᵢ) = χ_{R}⁽³⁾(2ωᵢ ≃ Ω_{R}\|E(ωᵢ)\|²E(ωᵢ) |
| CARS | ωₚ, ωₛ | visible/near-IR | difference | elastic | P_{R}⁽³⁾(ωₐ) = χ_{R}⁽³⁾(ωₚ − ωₛ ≃ Ω_{R})E²(ωₚ)E*(ωₛ) |
| | | (>>Ω_{R}) | | | |
| SRS | ωₚ, ωₛ | visible/near-IR | difference | inelastic | P_{R}⁽³⁾(ωₛ) = χ_{R}⁽³⁾(−ωₚ + ωₛ ≃ −Ω_{R})\|E(ωₚ)\|²E(ωₛ) |
| | | (>>Ω_{R}) | | | |

The above model can also be applied to analyze SRS and CARS, both of which require two high-frequency laser beams usually in the visible or near-IR range, a pump beam E(ωₚ)e^{-iω}^{ᵢ}^{t}+c.c. and a Stokes beam E(ωₛ)e^{-iω}^{ₛ}^{t}+c.c. with ωₛ=ωₚ−Ω_{R}. The Raman-active phonon is resonantly driven by the difference-beat frequency, such that

$$\begin{matrix}{Q}_{R} ( t ) = {Q}_{R} ( {ω}_{p} - {ω}_{s} ) {e}^{- i ( {ω}_{p} - {ω}_{s} ) t} + c . c . , where \\ {Q}_{R} ( {ω}_{p} - {ω}_{s} ) = \frac{{Π}_{0}}{M [ {Ω}_{R}^{2} - {( {ω}_{p} - {ω}_{s} )}^{2} - 2 i Γ ( {ω}_{p} - {ω}_{s} ) ]} E ( {ω}_{p} ) {E}^{*} ( {ω}_{s} )\end{matrix} . \qquad ( A8 )$$

Substituting Q_{R}(t) into Eq. A1, we derive one third-order polarization term at the anti-Stokes frequency ωₐ=ωₚ+Ω_{R}, and another at the Stokes frequency co:

$$\begin{matrix}{P}_{R}^{( 3 )} ( {ω}_{a} ; {ω}_{p} , - {ω}_{s} , {ω}_{p} ) = {Π}_{0} {Q}_{R} ( {ω}_{p} - {ω}_{s} ) E ( {ω}_{p} ) \\ = {χ}_{R}^{( 3 )} ( {ω}_{p} - {ω}_{s} ≃ {Ω}_{R} ) {E}^{2} ( {ω}_{p} ) {E}^{*} ( {ω}_{s} )\end{matrix} , \qquad ( A9 )$$

which describes the origin of CARS, with

$${χ}_{R}^{( 3 )} ( {ω}_{p} - {ω}_{s} ) = \frac{{Π}_{0}^{2}}{M [ {Ω}_{R}^{2} - {( {ω}_{p} - {ω}_{s} )}^{2} - 2 i Γ ( {ω}_{p} - {ω}_{s} ) ]} . \qquad ( A10 )$$

Compared to Eq. A5, both CARS and PM-THG involve driving Raman-active phonon coherence as an intermediate step, albeit through different routes—the former via a difference-frequency pathway, and the latter via a sum-frequency pathway. As FIG. 9 shows, CARS and PM-THG are both elastic FWM processes, where the Raman coherence increases the optical scattering cross-section but all incident energy is returned to the optical fields. Therefore, we regard PM-THG as a low-frequency, single-laser-excitation variant of CARS.

The nonlinear polarization term at the Stokes frequency is

$$\begin{matrix}{P}_{R}^{( 3 )} ( {ω}_{s} ; - {ω}_{p} , {ω}_{s} , {ω}_{p} ) = {Π}_{0} {Q}_{R} ( - {ω}_{p} + {ω}_{s} ) E ( {ω}_{p} ) \\ = {χ}_{R}^{( 3 )} ( - {ω}_{p} + {ω}_{s} ≃ - {Ω}_{R} ) {\vert E ( {ω}_{p} ) \vert}^{2} E ( {ω}_{s} )\end{matrix} , \qquad ( A11 )$$

which represents the origin of SRS. The corresponding Raman susceptibility, χ_{R}⁽³⁾(−ωₚ+ωₛ ≃−Ω_{R}), is negative imaginary, suggesting an exponential growth of the Stokes field at a rate proportional to the pump intensity |E(ωₚ)|². Similar to TPA (Eq. A7), optical field energy is absorbed to drive lattice vibrations, and thus not conserved in SRS. Therefore, as illustrated in FIGS. 9 (a) and (c), SRS and TPA are inelastic optical processes that accompany Raman coherence establishment via difference-frequency and sum-frequency pathway, respectively. Phase matching is automatically fulfilled in these two processes.

The relationships and features of the four processes (PM-THG, TPA, CARS, and SRS) are summarized in FIG. 9 and Table I.

### Raman Microscopy Measurements

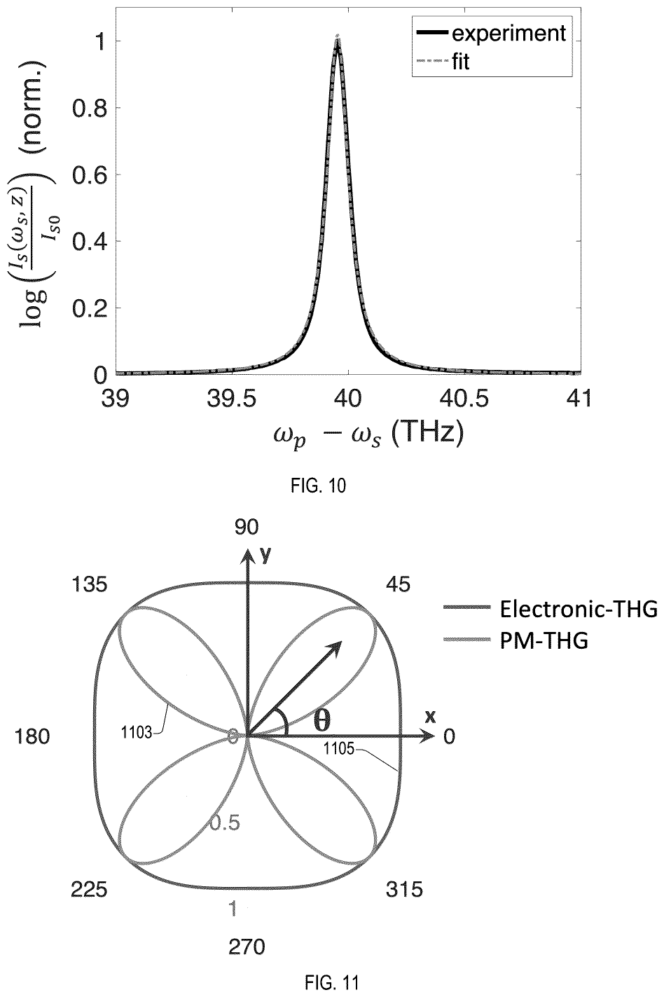

FIG. 10 shows the spectral intensity of the spontaneous Raman signal generated from the diamond sample. This signal was acquired through transmission measurements using a WITec Alpha300R confocal Raman microscope equipped with a CW laser operating at a 932 nm wavelength.

The evolution of the Raman signal amplitude Aₛ(ωₛ, z) propagating along the z-axis (the [001] axis of crystal) is

$$\frac{{dA}_{s} ( {ω}_{s} , z )}{dz} = - α ( {ω}_{s} ) {A}_{s} ( {ω}_{s} , z ) \qquad ( B1 )$$

within the slowly varying amplitude approximation. Here, z is the propagation distance, and ωₛ represents the Raman signal frequency. α(ωₛ) is defined as an absorption coefficient,

$$α ( {ω}_{s} ) = - i \frac{{ω}_{s}}{2 {ϵ}_{0} n ( {ω}_{s} ) c} {χ}_{R}^{( 3 )} ( - {ω}_{p} + {ω}_{s} ) {\vert {A}_{p} \vert}^{2} , \qquad ( B2 )$$

where ϵ₀ is the vacuum permittivity, n(ωₛ) is the linear refractive index, and c is the speed of light. Aₚ represents the electric field amplitude of the pump at frequency ωₚ, which is treated as a constant with no depletion here due to the low efficiency of the spontaneous Raman scattering. χ_{R}⁽³⁾ is the Raman susceptibility given by Eq. A10.

The solution of Eq. B1 is

$${A}_{s} ( {ω}_{s} , z ) = {A}_{s} ( {ω}_{s} , 0 ) {e}^{- α ( {ω}_{s} ) z} , \qquad ( B3 )$$

and thus the intensity of the Raman signal is

$${I}_{s} ( {ω}_{s} , z ) = 2 {ϵ}_{0} n ( {ω}_{s} ) {\vert {A}_{s} ( {ω}_{s} , z ) \vert}^{2} = {I}_{s 0} {e}^{- 2 Re ( α ( {ω}_{s} ) ) z} . \qquad ( B4 )$$

When there is only one incident beam at ωₚ, the input Raman signal Iₛ(ωₛ, z) at z=0 arises solely from quantum noise, and thus may be treated as a constant Iₛ₀ over a narrow frequency band near the Stokes frequency, ωₚ−Ω_{R}.

TABLE II

| References | [6]° | [3]* | [2]* | [2]° | [4]* | [1]° | Our results |
|---|---|---|---|---|---|---|---|
| Resonant | 39.95 ± | 39.95 ± | 39.91 | 39.84 ± | 39.93 | \ | 39.1352 ± |
| frequency f_{R} | 0.01 | 0.015 | | 0.03 | | | 0.002 |
| (THz) | | | | | | | |
| Line width γ | 0.045 | 0.0495 ± | 0.023 | 0.023 ± | 0.031 | 0.055 ± | 0.056 ± |
| (THz) | | 0.0006 | | 0.006 | | 0.006 | 0.003 |

After a log transformation, Eq. B4 becomes

$$\begin{matrix}log ( \frac{{I}_{s} ( {ω}_{s} , z )}{{I}_{s 0}} ) = - 2 Re ( α ( {ω}_{s} ) ) z \\ = β Re ( \frac{i {ω}_{s}}{{Ω}_{R}^{2} - {( {ω}_{p} - {ω}_{s} )}^{2} + 2 i Γ ( {ω}_{p} - {ω}_{s} )} )\end{matrix} , \qquad ( B5 )$$

where Ω_{R} represents the Raman resonant frequency, and F is the phonon line-width (half-width at half-maximum (HWHM)).

We take the baseline of the measured spectral intensities of the Raman signal (the intensity at frequencies several F away from the Stokes frequency) as the value of Iₛ₀.

$$β ( ≡ \frac{{Π}_{0}^{2} z}{{ϵ}_{0} n ( {ω}_{s} ) cM} {\vert {A}_{p} \vert}^{2} )$$

is a constant to be fitted, where the dispersion of the refractive index n(ωₛ) is neglected.

The black curve in FIG. 9 represents the measured spectral intensities of the Raman signal, Iₛ(ωₛ, z), after applying the log transformation described above, and is plotted against the frequency shift (ωₚ−ωₛ). A least-squares fitting of the parameters β, Ω_{R}, and Γ in Eq. B5 yields the orange curve, which closely matches the experimental data.

Table II compares our fitted values of f_{R}(=Ω_{R}/(2π)) and γ(=Γ/(2π)) with those reported in the literature for the F_{2g} Raman-active phonon in diamond [1-4, 6]. The resonant frequency (f_{R}) and the HWHM line-width (γ) for the F_{2g} phonon of diamond, as reported in prior literature and as observed in our experiments. In the top row, the star (*) represents the parameters obtained in the frequency domain. The open circle (^{∘}) represents the parameters obtained in the time domain, wherein γ is calculated as the phonon decay rate (in units of ps⁻¹) from [1, 2, 6], divided by 2π. Our f_{R} is consistent with previously reported values, while our γ falls on the higher side of a range of reported values that vary by a factor of ˜2.4. This variation is expected as the line width depends on the crystal quality and preparation.

### Pump Polarization Dependence Analysis of THG Signal Intensity

This section analyzes the pump polarization dependence of the PM-THG signal and the pure electronic THG signal by considering the vectorial nature of the pump field \vec{E} and third-order polarization field \vec{P}⁽³⁾.

Assuming the THz pump field, \vec{E}(t)=\vec{E}(ω₀)e^{-iω}^{₀}^{t}+c.c. with ω₀=Ω_{R}/2, is polarized along the θ direction within the x-y plane of the crystal, such that

$$\vec{E} ( {ω}_{0} ) = {E}_{0} [ \begin{matrix}cos θ & sin θ & 0\end{matrix} ] , \qquad ( C1 )$$

where x, y, and z correspond to the [100], [010], and [001] crystalline axes respectively, and E₀ represents the electric field amplitude.

From Eq. 1 in the main text, the phonon-mediated contribution to the third-order polarization \vec{P}⁽³⁾ at frequency of 3ω₀ is

$${P}_{R , i}^{( 3 )} ( 3 {ω}_{0} ) = {\sum }_{j} {Π}_{ij} {Q}_{R} {E}_{j} ( {ω}_{0} ) . \qquad ( C2 )$$

From Eq. 2 and the tensor form of Raman polarizability H provided in the main text, the coherent phonon amplitude is

$$\begin{matrix}{Q}_{R} = \frac{1}{M [ {Ω}_{R}^{2} - {( 2 {ω}_{0} )}^{2} - 2 i Γ ( 2 {ω}_{0} ) ]} {\sum }_{ij} {Π}_{ij} {E}_{i} ( {ω}_{0} ) {E}_{j} ( {ω}_{0} ) \\ = \frac{{Π}_{0}}{M [ {Ω}_{R}^{2} - {( 2 {ω}_{0} )}^{2} - 2 i Γ ( 2 {ω}_{0} ) ]} {E}_{0}^{2} sin ( 2 θ ) ,\end{matrix} \qquad ( C3 )$$

which has sin(2θ) dependence for the pump polarization angle, consistent with the analysis in Ref. [2].

Inserting Eq. C1 and C3 into Eq. C2, we obtain

$$\vec{{P}_{R}^{( 3 )}} ( 3 {ω}_{0} ) = {χ}_{R}^{( 3 )} ( 2 {ω}_{0} ) {E}_{0}^{3} sin ( 2 θ ) [ \begin{matrix}sin θ & cos θ & 0\end{matrix} ] . \qquad ( C4 )$$

Therefore, the intensity of PM-THG

$${I}_{R} ( 3 {ω}_{0} ) ∝ {\vert \vec{{P}_{R}^{( 3 )}} ( 3 {ω}_{0} ) \vert}^{2} = {\vert {χ}_{R}^{( 3 )} ( 2 {ω}_{0} ) \vert}^{2} {\vert {E}_{0} \vert}^{6} {sin}^{2} ( 2 θ ) , \qquad ( C5 )$$

which manifests as a sin²(2θ) dependency on the pump polarization angle, as curve 1103 in FIG. 11 shows. Such angle dependence is consistent with the conventional Raman signal generated from the same F_{2g} phonon in a diamond crystal using a visible pump, affirming the link between optical scattering physics in the THz domain through sum-frequency driving of Raman coherence and those through traditional difference-frequency coherence excitation with high-frequency light.

However, the pure electronic THG has a significantly different θ dependence. From Eq. 1 in the main text, the non-resonant electronic contribution to the third-order polarization \vec{P}⁽³⁾ at frequency of 3ω₀ is

$${P}_{e , i}^{( 3 )} ( 3 {ω}_{0} ) = {\sum }_{jkl} {χ}_{e , ijkl}^{( 3 )} {E}_{j} ( {ω}_{0} ) {E}_{k} ( {ω}_{0} ) {E}_{l} ( {ω}_{0} ) , \qquad ( C6 )$$

The diamond crystal, belonging to space group No. 227 (Fd3̅m), has two independent components of χ_{e,ijkl}⁽³⁾ dictated by Kleinman's symmetry relation: χ_{e,1111}⁽³⁾, and χ_{e,1221}⁽³⁾(=χ_{e,1212}⁽³⁾=χ_{e,1122}⁽³⁾), where the indices 1 and 2 denote two different Cartesian axes. For example, χ_{e,xxxx}⁽³⁾=χ_{e,yyyy}⁽³⁾=χ_{e,1111}⁽³⁾, and χ_{e,xxyy}⁽³⁾=χ_{e,xyxy}⁽³⁾=χ_{e,xyyx}⁽³⁾=χ_{e,1221}⁽³⁾. Therefore,

$$\begin{matrix}{P}_{e , x}^{( 3 )} ( 3 {ω}_{0} ) = {χ}_{e , xxxx}^{( 3 )} {E}_{x}^{3} ( {ω}_{0} ) + ( {χ}_{e , xyyx}^{( 3 )} + {χ}_{e , xyxy}^{( 3 )} + {χ}_{e , xxyy}^{( 3 )} ) {E}_{y}^{2} ( {ω}_{0} ) {E}_{x} ( {ω}_{0} ) \\ = [ {χ}_{e , 1111}^{( 3 )} {cos}^{3} ( θ ) + 3 {χ}_{e , 1221}^{( 3 )} {sin}^{2} ( θ ) cos ( θ ) ] {E}_{0}^{3} ,\end{matrix} \qquad ( C7 )$$

$$\begin{matrix}{P}_{e , y}^{( 3 )} ( 3 {ω}_{0} ) = {χ}_{e , yyyy}^{( 3 )} {E}_{y}^{3} ( {ω}_{0} ) + ( {χ}_{e , yxxy}^{( 3 )} + {χ}_{e , yxyx}^{( 3 )} + {χ}_{e , yyxx}^{( 3 )} ) {E}_{x}^{2} ( {ω}_{0} ) {E}_{y} ( {ω}_{0} ) \\ = [ {χ}_{e , 1111}^{( 3 )} {sin}^{3} ( θ ) + 3 {χ}_{e , 1221}^{( 3 )} {cos}^{2} ( θ ) sin ( θ ) ] {E}_{0}^{3} .\end{matrix} \qquad ( C8 )$$

By substituting the susceptibility values from Ref. [5], χ_{e,1111}⁽³⁾=4.60 (10⁻¹⁴ esu) and χ_{e,1221}⁽³⁾=1.72 (10⁻¹⁴ esu), into Eq. C7 and C8, we calculate the signal intensity of the non-resonant electronic THG, Iₑ(3ω₀)∝|\vec{Pₑ⁽³⁾}(3ω₀)|², as a function of the polarization angle θ.

FIG. 11 shows PM-THG (curve 1103) and the non-resonant electronic-THG (curve 1105) intensities as a function of the pump polarization angle θ, both normalized to their intensity at θ=45°. As curve 1105 shows, the non-resonant electronic THG is notably less sensitive to the pump polarization angle, with an only 1.12-fold difference between its maximum and minimum intensity.

### Derivation of PM-THG and Electronic THG for Pulsed Excitation and Calculation of Susceptibility Ratio

To simplify the analysis, we assumed the THz pump field E(t) to be monochromatic light in the sections entitled “Derivation of PM-THG and TPA” and “Pump Polarization dependence analysis of THG signal intensity.”. While this approach sufficiently illustrates the resonant behavior of PM-THG and its dependency on pump polarization angle, it cannot be applied to simulate the THG spectral intensity under excitation of a picosecond laser pump possessing a broad bandwidth. Furthermore, the susceptibility ratio

$$\vert \frac{{χ}_{R}^{( 3 )} ( {Ω}_{R} )}{{χ}_{e}^{( 3 )}} \vert$$

cannot be simply determined by the ratio between the square root of the THG signal intensity measured at θ=450 and that at θ=0°. Its calculation requires a more careful analysis involving the autoconvolution of the Fourier transform of the pulsed laser field E(t),

$$E ( t ) = \int \tilde{E} ( ω ) exp ( - i ω t ) d ω , \qquad ( D1 )$$

where \tilde{E}(ω) is the Fourier transform of E(t), and |\tilde{E}(ω)|² represents the intensity spectrum of the pump pulse. Again, we consider the pump field \vec{E} polarized along θ=45° in this section, and write \vec{E} and the third-order polarization \vec{P}⁽³⁾ in scalar form to simplify the analysis.

From Eq. 1, the Fourier transform of the pure electronic third-order polarization term Pₑ⁽³⁾(t) and the phonon-mediated polarization term P_{R}⁽³⁾(t) is

$${\tilde{P}}_{e}^{( 3 )} ( ω ) = [ {χ}_{e}^{( 3 )} ( \tilde{E} ( ω ) * \tilde{E} ( ω ) ) ] * \tilde{E} ( ω ) , \qquad ( D2 )$$

$${\tilde{P}}_{R}^{( 3 )} ( ω ) = {Π}_{0} {\tilde{Q}}_{R} ( ω ) * \tilde{E} ( ω ) . \qquad ( D3 )$$

In Eq. D2, the non-resonant third-order electronic susceptibility χₑ⁽³⁾(ω) is regarded as a constant χₑ⁽³⁾ with no dispersion in the THz region, because the photon energy is far below the bandgap of diamond (5.5 eV).

From Eq. 2, the transform of Q_{R}(t) is

$$M [ {( - i ω )}^{2} {\tilde{Q}}_{R} - 2 i Γ ω {\tilde{Q}}_{R} + {Ω}_{R}^{2} {\tilde{Q}}_{R} ] = {Π}_{0} \tilde{E} * \tilde{E} , \qquad ( D4 )$$

where * represents linear convolution. The analytical solution of Eq. D4 is

$${\tilde{Q}}_{R} ( ω ) = \frac{{Π}_{0}}{M ( {Ω}_{R}^{2} - {ω}^{2} - 2 i Γ ω )} ( \tilde{E} ( ω ) * \tilde{E} ( ω ) ) . \qquad ( D5 )$$

By substituting \tilde{Q}_{R}(ω) into Eq. D3, we obtain

$$\begin{matrix}{\tilde{P}}_{R}^{( 3 )} ( ω ) = [ \frac{{Π}_{0}^{2}}{M ( {Ω}_{R}^{2} - {ω}^{2} - 2 i Γ ω )} ( \tilde{E} * \tilde{E} ) ] * \tilde{E} \\ ≡ [ {χ}_{R}^{( 3 )} ( ω ) ( \tilde{E} ( ω ) * \tilde{E} ( ω ) ) ] * \tilde{E} ( ω ) ,\end{matrix} \qquad ( D6 )$$

where the Raman susceptibility χ_{R}⁽³⁾(ω) is given by

$$\begin{matrix}{χ}_{R}^{( 3 )} ( ω ) = \frac{{Π}_{0}^{2}}{M ( {Ω}_{R}^{2} - {ω}^{2} - 2 i Γ ω )} \\ = {χ}_{e}^{( 3 )} η ( \frac{2 Γ {Ω}_{R}}{{Ω}_{R}^{2} - {ω}^{2} - 2 i Γ ω} )\end{matrix} \qquad ( D7 )$$

with an introduced constant η, defined as

$$η = \frac{{Π}_{0}^{2}}{M ( 2 Γ {Ω}_{R} ) {χ}_{e}^{( 3 )}} . \qquad ( D8 )$$

By integrating the measured pump spectra shown in Section (b) of FIG. 2, alongside the phonon parameters determined in Appendix B, into Eq. D2 and D6, we derive the respective signal spectra for each of the PM-THG mechanism (|\tilde{P}_{R}⁽³⁾(ω)|²) and the pure electronic-THG mechanism (|\tilde{P}_{R}⁽³⁾(ω)|²), as shown in FIGS. 2(c) and (d) respectively.

The constant η is introduced in Eq. D7 since it directly defines the ratio between |χ_{R}⁽³⁾(ω)| at the phonon resonance and |χₑ⁽³⁾|. By equating the THG enhancement factor of 113 measured at resonance to |(P_{R}⁽³⁾+Pₑ⁽³⁾)/Pₑ⁽³⁾)|², we can deduce the value of the constant η and thus the susceptibility ratio:

$$η = \vert \frac{{χ}_{R}^{( 3 )} ( ω = {Ω}_{R} )}{{χ}_{e}^{( 3 )}} \vert \geq 58. \qquad ( D9 )$$

Due to experimental uncertainty in polarization purity, there may be some phonon-mediated contribution to the measured THG signal at θ=0°, potentially leading to an underestimation of the actual enhancement factor. Therefore, we incorporate this uncertainty by utilizing the inequality notation in this expression.

The susceptibility ratio we obtained is approximately three times the value of 21(±3) reported in Ref. [4]. This discrepancy can be attributed to different definitions of nonlinear susceptibility for different nonlinear optical processes. Embodiments disclosed herein include THG processes with a purely electronic susceptibility given by χₑ⁽³⁾(3ω₀; ω₀, ω₀, ω₀)=χ_{e,1111}⁽³⁾+3χ_{e,1221}⁽³⁾ for a pump field along the [110] direction (see Appendix C). However, Ref. [20] examines a FWM process with a purely electronic susceptibility χₑ⁽³⁾(2ω₁+ω₂; ω₁, ω₁, −ω₂)=3(χ_{e,1111}⁽³⁾+3χ_{e,1221}⁽³⁾) when two incident light fields at ω₁ and ω₂ are both along the [110] direction. The electronic susceptibility in the FWM process is three times that of the THG process, resulting in a lower susceptibility ratio between χ_{R}⁽³⁾ and χₑ⁽³⁾, as reported in Ref. [20]. Additionally, embodiments disclosed herein employ a laser in the THz range (an example of light source 510), while the pump source in Ref. [20] operates in the visible range with photon energy closer to the bandgap. Variations in the third-order electronic susceptibility across different frequency ranges may also contribute to the observed difference in susceptibility ratios.

### THG Suppression

FIG. 12 presents the pump spectra corresponding to the signal spectra shown in section (d) of FIG. 3, below and above the half phonon resonance f_{R}/2, respectively. FIG. 13 displays the real and imaginary parts of the Raman susceptibility χ_{R}⁽³⁾(ω/2π), normalized to the frequency-independent electronic susceptibility χₑ⁽³⁾. When the pump has a center frequency fᵢ=f_{R}/2, the corresponding Raman susceptibility χ_{R}⁽³⁾(ω/2π=2fᵢ) is pure imaginary at Raman resonance. As the pump frequency deviates from f_{R}/2, the imaginary part of χ_{R}⁽³⁾ rapidly diminishes to zero, while the real part starts to dominate the generation of the PM-THG signal.

For instance, the center frequency of pump in FIG. 12 corresponds to a Raman susceptibility χ_{R}⁽³⁾(ω) whose real part is much higher than its imaginary part, marked by the dashed line \textcircled{1} in FIG. 13. When the real part of χ_{R}⁽³⁾(ω) has the same sign as χₑ⁽³⁾, the phonon-mediated and electronic contributions to the polarization field combine constructively and thus enhance the total THG efficiency, as observed in FIG. 3, section (d). However, the enhancement factor at this pump frequency is significantly smaller than at resonance.

FIG. 13 is a plot of the real part 1301 and imaginary part 1302 of the Raman susceptibility χ_{R}⁽³⁾ as a function of ω (Eq. D7), normalized to the frequency-independent third-order electronic susceptibility χₑ⁽³⁾ (horizontal line 1303). The dashed lines represent twice the center frequency of pump \textcircled{1} and \textcircled{2} in FIG. 12.

Conversely, when the pump frequency fᵢ is tuned above f_{R}/2, the real part of χ_{R}⁽³⁾ flips its sign, leading to destructive interference between PM-THG and electronic-THG polarization fields. Therefore, for the center frequency of pump \textcircled{2} in FIG. 12 (marked by the dashed line \textcircled{2} in FIG. 13), the total THG intensity is suppressed below the pure electronic THG, as seen in FIG. 3, section (d). Notably, the THG signal cannot be completely eliminated even with a perfect cancellation between χₑ⁽³⁾ and the real part of χ_{R}⁽³⁾(ω), as a result of the minor contribution from the imaginary part of χ_{R}⁽³⁾. This explains why the minimum enhancement factor, illustrated in section (b) of FIG. 4, is not strictly zero but rather on the order of 10⁻⁴.

### Combinations of Features

Features described above as well as those claimed below may be combined in various ways without departing from the scope hereof. The following enumerated examples illustrate some possible, non-limiting combinations.

Embodiment 1A. A phonon-mediated upconversion method includes exciting a Raman phonon in a crystal by illuminating the crystal with a number of pump beams each having a same pump frequency equal to one half of a phonon frequency of the Raman phonon. The method also includes generating an upconverted beam by illuminating the crystal with at least one of the number of pump beams while the Raman phonon is at least partially excited. The upconverted beam has an upconverted frequency that is three times the pump frequency.

Embodiment 1B. A phonon-mediated upconversion method includes exciting a Raman phonon in a crystal by illuminating the crystal with a plurality of pump beams each having a respective one of a plurality of pump frequencies. A phonon frequency of the Raman phonon being equal to either (i) two times one of the plurality of pump frequencies or (ii) a sum of the plurality of pump frequencies. The method also includes generating an upconverted beam by illuminating the crystal with at least one of the plurality of pump beams while the Raman phonon is at least partially excited. The upconverted beam has an upconverted frequency equal to either (i) the phonon frequency plus one of the plurality of pump frequencies or (ii) the phonon frequency minus one of the plurality of pump frequencies.

Embodiment 1C. A phonon-mediated upconversion method includes exciting a Raman phonon in a crystal by illuminating the crystal with three pump beams. Each of the three pump beams has a respective one of three distinct pump frequencies. A phonon frequency of the Raman phonon is equal to a sum of two of the three distinct pump frequencies. The method also includes generating an upconverted beam by illuminating the crystal with the three pump beams while the Raman phonon is at least partially excited. The upconverted beam has an upconverted frequency equal to either (i) a sum of the three distinct pump frequencies or (ii) the phonon frequency minus one of the three distinct pump frequencies.

Embodiment 2. The method of any one of embodiments 1A-1C, the number of pump beams being equal to one.

Embodiment 3. The method of any one of embodiments 1A-1C and 2, the number of pump beams being equal to two.

Embodiment 4. The method of any one of embodiments 1A-1C, 2 and 3, the number of pump beams being equal to three.

Embodiment 5. The method of any one of embodiments 1A-1C and 2-4, the at least one of the number of pump beams including each of the number of pump beams.

Embodiment 6. The method of any one of embodiments 1A-1C and 2-5, any of said pump frequencies being in the terahertz region or the mid-infrared region of the electromagnetic spectrum.

Embodiment 7. The method of any one of embodiments 1A-1C and 2-6, the number of pump beams being linearly polarized and propagating perpendicular to a crystal plane of the crystal.

Embodiment 8. The method of any one of embodiments 1A-1C and 2-7, the crystal being diamond.

Embodiment 9. The method of any one of embodiments 1A-1C and 2-8, one or more of the number of pump beams being pulsed.

Embodiment 10. The method of any one of embodiments 1A-1C and 2-9, the Raman phonon having symmetry.

Embodiment 11. The method of any one of embodiments 1A-1C and 2-10, the Raman phonon being an optical phonon.

Embodiment 12. The method of any one of embodiments 1A-1C and 2-11, the Raman phonon being infrared-inactive.

Embodiment 13. The method of any one of embodiments 1A-1C and 2-12, further comprising modulating the intensity of the upconverted beam by changing an angle between (i) a plane of polarization of at least one of the number of pump beams and (ii) a crystal axis of the crystal.

Embodiment 14. The method of any one of embodiments 1A-1C and 2-13, the plurality of pump beams consisting of two pump beams.

Embodiment 15. The method of any one of embodiments 1A-1C and 2-14, the plurality of pump beams consists of three pump beams.

Embodiment 16. The method of any one of embodiments 1A-1C and 2-15, the at least one of the plurality of pump beams including each of the plurality of pump beams.

Embodiment 17. The method of any one of embodiments 1A-1C and 2-16 may further include directing the upconverted beam into a spectrometer.

### REFERENCES

[1] A. Laubereau, D. Von der Linde, and W. Kaiser, Phys. Rev. Lett. 27, 1202 (1971).
[2] K. Ishioka, M. Hase, M. Kitajima, and H. Petek, Appl. Phys. Lett. 89, 231916 (2006).
[3] S. Solin and A. Ramdas, Phys. Rev. B 1, 1687 (1970).
[4] M. Levenson, C. Flytzanis, and N. Bloembergen, Phys. Rev. B 6, 3962 (1972).
[5] M. Levenson and N. Bloembergen, Phys. Rev. B 10, 4447 (1974).
[6] S. Maehrlein, A. Paarmann, M. Wolf, and T. Kampfrath, Phys. Rev. Lett. 119, 127402 (2017).

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B” and “at least one of A and B,” such phrasing encompasses the selection of (i) A only, or (ii) B only, or (iii) both A and B. In the cases of “A, B, and/or C” and “at least one of A, B, and C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

We claim:

1. A phonon-mediated upconversion method, comprising:
exciting a Raman phonon in a crystal by illuminating the crystal with a number of pump beams each having a same pump frequency equal to one half of a phonon frequency of the Raman phonon; and
generating an upconverted beam by illuminating the crystal with at least one of the number of pump beams while the Raman phonon is at least partially excited, the upconverted beam having an upconverted frequency that is three times the pump frequency.

2. The method of claim 1, the number of pump beams being equal to one.

3. The method of claim 1, the number of pump beams being equal to two.

4. The method of claim 1, the number of pump beams being equal to three.

5. The method of claim 1, the at least one of the number of pump beams including each of the number of pump beams.

6. The method of claim 1, the pump frequency being in the terahertz region or the mid-infrared region of the electromagnetic spectrum.

7. The method of claim 1, the number of pump beams being linearly polarized and propagating perpendicular to a crystal plane of the crystal.

8. The method of claim 1, the crystal being diamond.

9. The method of claim 1, one or more of the number of pump beams being pulsed.

10. The method of claim 1, the Raman phonon having F_{2g} symmetry.

11. The method of claim 1, the Raman phonon being an optical phonon.

12. The method of claim 1, the Raman phonon being infrared-inactive.

13. The method of claim 1, further comprising modulating the intensity of the upconverted beam by changing an angle between (i) a plane of polarization of at least one of the number of pump beams and (ii) a crystal axis of the crystal.

14. A phonon-mediated upconversion method, comprising:
exciting a Raman phonon in a crystal by illuminating the crystal with a plurality of pump beams each having a respective one of a plurality of pump frequencies, a phonon frequency of the Raman phonon being equal to either (i) two times one of the plurality of pump frequencies or (ii) a sum of the plurality of pump frequencies; and
generating an upconverted beam by illuminating the crystal with at least one of the plurality of pump beams while the Raman phonon is at least partially excited, the upconverted beam having an upconverted frequency equal to either (i) the phonon frequency plus one of the plurality of pump frequencies or (ii) the phonon frequency minus one of the plurality of pump frequencies.

15. The method of claim 14, the plurality of pump beams consisting of two pump beams.

16. The method of claim 14, the plurality of pump beams consisting of three pump beams.

17. The method of claim 14, the at least one of the plurality of pump beams including each of the plurality of pump beams.

18. The method of claim 14, one or more of the plurality of pump frequencies being in the terahertz or the mid-infrared regions of the electromagnetic spectrum.

19. A phonon-mediated upconversion method, comprising:
exciting a Raman phonon in a crystal by illuminating the crystal with three pump beams, each of the three pump beams having a respective one of three distinct pump frequencies; a phonon frequency of the Raman phonon being equal to a sum of two of the three distinct pump frequencies; and
generating an upconverted beam by illuminating the crystal with the three pump beams while the Raman phonon is at least partially excited, the upconverted beam having an upconverted frequency equal to either (i) a sum of the three distinct pump frequencies or (ii) the phonon frequency minus one of the three distinct pump frequencies.

20. The method of claim 19, one or more of the three distinct pump frequencies being in the terahertz region or the mid-infrared region of the electromagnetic spectrum.

21. The method of claim 19, further comprising directing the upconverted beam into a spectrometer.
